(19) United States
(12) Patent Application Publication
(10) Pub. No.: US 2021/0124791 A1
(43) Pub. Date: Apr. 29, 2021

(54) INFORMATION PROVISION SYSTEM USING PHYSICAL MEDIA,AND INFORMATION PROVISION METHOD

(71) Applicant: Takashi Imagawa, Aichi (JP)

(72) Inventor: Takashi Imagawa, Aichi (JP)

(21) Appl. No.: 16/992,651

(22) Filed: Aug. 13, 2020

Related U.S. Application Data
(63) Continuation of application No. PCT/JP2019/005450, filed on Feb. 14, 2019.

(30) Foreign Application Priority Data
Feb. 14, 2018 (JP) 2018-024579

(51) Int. Cl. G06F 16/955; G06F 16/951

(52) U.S. Cl. CPC G06F 16/9566; G06F 16/951; G06F 16/9558; G06F 16/9562

(57) ABSTRACT

To construct an information system or an information network focusing on a physical medium and provide a predetermined information composed of a series of information or the like that has a relation in terms of a time and/or a place and/or a context. The information providing system includes an ID storage medium that is attached to a specific physical medium to store a unique ID identifying a specific tangible object, an information recording means of making a computer realize a function of recording an ID of one tangible object in a storage means when a user reads out the ID storage medium at a specific location, where the ID storage medium is physically present, by a terminal device having an ability to read the ID of the ID storage medium, and an information retrieving means of providing the user with a function of retrieving information about the tangible object uniquely corresponding to the ID recorded in the storage means.

### CROSS-REFERENCE TO RELATED APPLICATIONS

This application is a bypass continuation of PCT/JP2019/005450 entitled “INFORMATION PROVIDING SYSTEM USING PHYSICAL MEDIA, AND INFORMATION PROVIDING METHOD” published by WIPO as WO2019/160063 (which is incorporated by reference herein in its entirety for all purposes) which claims convention priority to Japanese patent application JP 2018-024579, filed in the Japanese Patent Office on Feb. 14, 2018 (which is incorporated by reference herein in its entirety for all purposes).

### TECHNICAL FIELD

The present invention relates to an information providing system and an information providing method that utilize commercial items or a variety of physical media having physical body characteristics such as commercial products or print advertising media and/or that utilizes a screen of a liquid crystal display as a physical media such as a an information terminal device having a liquid crystal display, so as to provide a predetermined information such as an information consisting of a series of information having temporal and/or locational and/or contextual relationship.

### BACKGROUND ART

### Bookmark Function

As one of the functions of a web browser for viewing websites on the Internet, there is a function called bookmarks (hereinafter referred to simply as “bookmarking function”).

Conventional bookmarking functions are nothing but techniques to facilitate an access to an entity or a website that is provided virtually on the Internet (e.g., a website of an online shop as a virtual shop on the Internet or a website of a manufacturer of a specific commercial product that is provided virtually on the Internet).

### New Technology by Fusing ID Technique such as NFC and Bookmarking Function

Here, the inventor wondered whether it would be possible to associate the conventional bookmarking function with a tangible object as a physical entity rather than a virtual entity, such as a specific product itself that the user is interested in, or a tangible object of a specific brick-and-mortar store that the user is interested in. Then, the inventor made keen research and development of a technology that would enable such a thing to be done. On the other hand, the inventor wondered whether the idea of the conventional bookmarking function could be applied to the construction of an information network of a novel idea using the above-mentioned NFC. Then, the inventor made keen research and development on the technology that would enable such a thing to be done. As a result, the present inventor has come up with a system for providing information utilizing a physical medium oaccording to the present invention.

### Novel Object of Invention

Therefore, a first object of the present invention is to provide an information providing system and an information providing method that utilize a variety of physical media having commercial item characteristics (property as a commercial item) or physical body characteristics (property as physical object) such as commercial products or print advertising media and, in addition thereto, that utilizes a screen of a liquid crystal display as a physical media such as a an information terminal device having a liquid crystal display, so as to provide a predetermined information such as an information consisting of a series of information having temporal and/or locational and/or contextual relationship.

Moreover, it may be another object (second object) of the present invention to provide an information providing system and an information providing method utilizing a physical medium that can construct an information system or an information service that uses the commercial item characteristics or the physical body characteristics and that can construct a useful information providing service that uses the commercial item characteristics or the physical body characteristics, by providing a variety of predetermined informations that can be linked to the physical medium (hereinafter referred to as “physical medium linked information”), such as an information related to the physical medium (hereinafter referred to as “physical medium-related information”), an information specific to or an information related to a geographical information or a locational information where the physical medium is located although not having any relation with the physical medium (hereinafter referred to as “physical medium location information”).

Furthermore, it may be still another object (third object) of the present invention to provide an information providing system and an information providing method utilizing a physical medium that, by simply recording an ID (local ID or node ID) of an object at some place when he or she actually experiences the object at an arbitrary location on a physical world, can retrieve and confirm reliably and effectively an information on the object even after a lapse of considerable amount of time and even at another location.

In addition, it may be still another object (third object) of the present invention to provide an information providing system and an information providing method utilizing a physical medium that, by assigning nodes that correspond respectively to arbitrary objects in the physical world and forming a link between the nodes with an edge and by assigning arbitrary attributes respectively to the nodes and the edge, can construct a data structure, which has a configuration corresponding to a representation composed of a subject, a predicate, by use of two nodes and one edge.

### SOLUTION TO PROBLEM

An information providing system utilizing a physical medium according to the present invention comprises: a local ID issuing means of making a computer realize a function of assigning and issuing a local ID, the local ID being a single kind of ID assigned to each of plural kinds of objects having different attributes, the local ID being a unique identifier for identifying the objects, and the local ID being assigned and issued to each of the objects; a first storing means of making the computer realize a first storing function of storing in a database the local ID issued for each of the objects, while relating the local ID to an URI of an attribute information proper to the object, and storing in the database, as the URI, at least an external URI, the external URI being a URI associated with an external system; a second storing means of making the computer, when an information viewer reads out the local ID of the object by an ID reading means of an information viewer terminal as a computer device for viewing information, realize a second storing function of storing in the database the local ID, while relating the local ID to the information viewer; a first display means of making the computer realize a first display function of assigning a link to the URI for each of the local IDs based on the local ID and the URI that are stored in the database, and displaying a title associated with the URI, which is related to the local ID that has been read out by the information viewer through the ID reading means, on the information viewer terminal of the information viewer; and a second display means of making the computer, when the information viewer selects and executes the link of the URI of the object displayed on the information viewer terminal, realize a second display function of displaying the attribute information proper to the object on the information viewer terminal.

### BRIEF DESCRIPTION OF DRAWINGS

FIG. 1 is an explanatory drawing showing an overall configuration of an information providing system using a physical medium in accordance with a first embodiment of the present invention, while being schematically illustrated by functional blocks.

FIG. 2 is an explanatory drawing showing one part of a data structure of a management database of the information providing system using the physical medium in accordance with the first embodiment of the present invention, while being schematically illustrated by an ER diagram.

FIG. 3 is an explanatory drawing showing another part of a data structure of a management database of the information providing system using the physical medium in accordance with the first embodiment of the present invention, while being schematically illustrated by an ER diagram.

FIG. 4 is an explanatory drawing showing a memory registration process of the information providing system using the physical medium in accordance with the first embodiment of the present invention, while being schematically illustrated by functional blocks and the like.

FIG. 5 is a flowchart illustrating a series of information processing steps of the information providing system using the physical medium in accordance with the first embodiment of the present invention, as a process at the time of first reading of My Memory.

FIG. 6 is a flowchart illustrating a series of information processing steps of a post-login process of the information providing system using the physical medium in accordance with the first embodiment of the present invention.

FIG. 7 is a flowchart illustrating a series of information processing steps as a My Memory process of the information providing system using the physical medium in accordance with the first embodiment of the present invention.

FIG. 8 is a flowchart illustrating a series of information processing steps of a memory service process (memory creation process) of the information providing system using the physical medium in accordance with the first embodiment of the present invention.

FIG. 9 is a flowchart illustrating a series of information processing steps of a memory service process (memory management process) of the information providing system using the physical medium in accordance with the first embodiment of the present invention.

FIG. 10 is an explanatory drawing for showing an example of a case in which a data structure is formed by a subject/predicate/object relationship in a link structure (network structure) of the information providing system using the physical medium in accordance with the first embodiment of the present invention.

### EMBODIMENTS OF INVENTION

A form for embodying the present invention (hereinafter referred to as an “embodiment”) will be described below. Throughout each of embodiments, the same parts, elements, or portions are attached with the same reference signs to omit their description.

In the present application documents, an identifier (local ID) to be given to the aborementioned specific object is referred to as a “local ID” in the sense that it is a unique ID for the specific object linked to a specific location and a specific time information. The local ID is referred to as a “commercial item ID” in the sense that it is issued in a one-to-one relationship to a specific “commercial item” in case it is issued in a one-to-one relationship to a specific commercial product as the commercial item or to a specific informational print article as the commercial item.

### Physical Media Providing Field

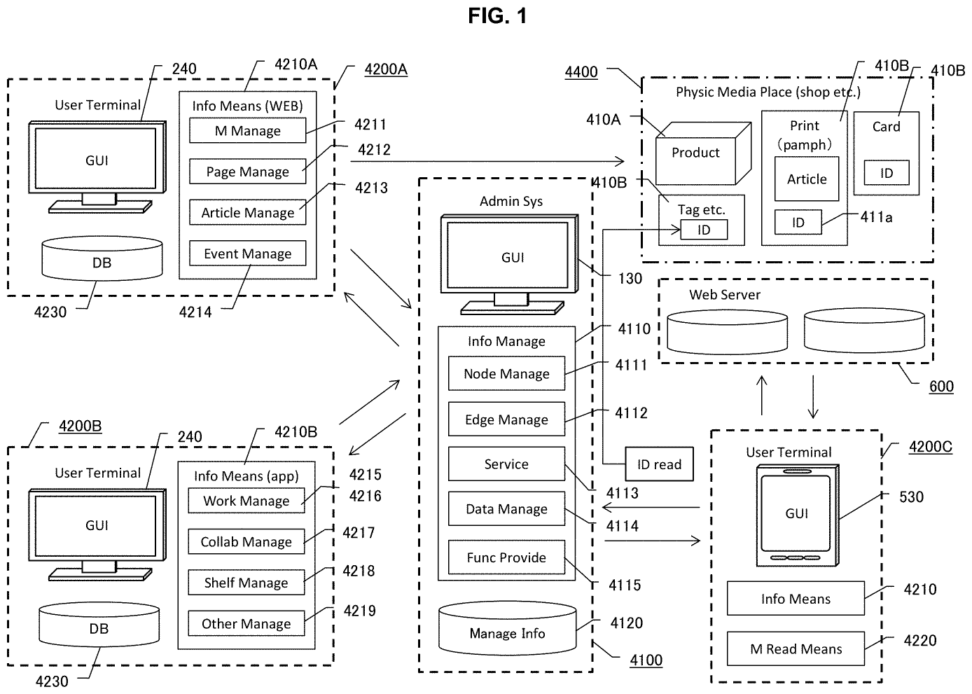

Next, referring to FIG. 1, a physical media providing field 4400, which is indispensable to construct the present information providing system, will be described in detail. In this information providing system, the physical media providing field 4400 is a place having a specific geographic information or a specific locational information. That is, the physical media providing field 4400 is a place to be uniquely identified by the geographic information or the locational information such as an address, a store name, or a geographic coordinate based on a combination of a latitude and a longitude. That is, the physical media providing field 4400 is a place where a specific physical medium is provided or presented to an outside world by exhibiting, displaying, selling, etc. In detail, the physical media providing field 4400 is a physical store or the like such as a restaurant, a store selling commercial items, and so on, which exist in a particular location. The physical media providing field 4400 is a place to provide or present, as a physical medium, a variety of commercial products 410A, which are constituted by a variety of physical/actual commercial products such as liquors, watches, and so on, and to provide and/or a variety of informational printed materials 410B such as posters, flyers, pamphlets, brochures, catalogs, etc., on which a commercial article about a specific product/service and the like is posted. Whenever the term “commercial item” is used in the present application documents, it includes commercial items in the narrow sense of the word, which are tangible commercial items, as well as services, which are intangible commercial items. Further, in the present application documents, the term “commercial item” may be used as a term for a concept that encompasses these commercial products 410A and informational printed materials 410B. Moreover, in the present application documents, the physical medium that can be provided for the use of the present information providing system by attaching the aforementioned local ID may be composed of a physical advertising medium such as a signage, and, in addition, a building or a structure such as a house and the like, etc. Thus, with respect to the physical medium, the term “object” is used in the sense that it includes a physical medium other than the commercial items as described above.

### Commercial Item ID as Local ID

Next, the description is made on the local ID in cae of using the commercial product 410A (which is a narrowly defined commercial product) as the physical medium of the physical medium provider field 4400. In this case, a commercial item ID medium 411 as a local ID medium is affixed, by adhesion or the like, to the commercial product 410A so that it can be read from the outside. In detail, the commercial item ID medium 411 is composed of an arbitrary ID-providing medium that provides a commercial item ID as a local ID, which is a unique ID (identifier), such as an NFC tag, an RFID tag, a barcode (one-dimensional barcode or two-dimensional barcode), etc., such that the ID is associated with a specific commercial product 410A as a unique identification target in the present information-providing system and such that the ID is readable from the outside. Typically, the commercial item ID medium 411 is attached to a packaging, container, a label, and the like of a particular commercial product 411A, which is displayed or put in other way in a particular store, so as to provide the commercial item ID for uniquely identifying the particular commercial product (commercial item) in such a manner to be read from the outside. Thus, the commercial item ID medium 411 is attached to the specific commercial product 410A, thereby being associated or linked with the particular commercial product 410A, while being in a one-to-one relationship with the particular commercial product 410A.

### Acquisition of Commercial Product Information by Commercial Item ID

With such configuration, a predetermined commercial product information made of attributes of the particular commercial product 410A (product name, price, product images such as product pictures, manufacturer name, quality, campaign information, product features, etc.) are associated with the commercial item ID of the commercial item ID medium 411, while being stored in a storage area such as a predetermined database in such a manner to be readable from the outside. Thus, if someone reads the commercial item ID of the commercial item ID medium 411 by a predetermined ID reading means, he or she can acquire the predetermined merchandise information of the particular commercial product 410A that is associated with the commercial item ID of the commercial item ID medium 411.

### Acquisition of Physical Store Information by Commercial Item ID

The commercial item ID medium 411 can also associate the commercial item ID with attributes of the physical or actual store to which the particular commercial item 410A belongs (store address, store name, contact information such as phone number, store image such as store photo, map information of the store's surroundings, etc.).

### Acquisition of Article Information in Informational Printed Material by Commercial Item ID

The informational printed material 410B includes posters, flyers, brochures, catalogues, etc., which are displayed, installed, distributed, or put in other manners, in a particular store or house. The informational printed material 410B has a specific article printed thereon in a corresponding area of a particular place thereof. The commercial item ID medium 411a is attached in the vicinity of each of the particular articles in the informational printed material 410B, by printing or by affixing (attachment by a sticker or a tag) or by other means. Each of the commercial item ID media 411A provides the commercial item ID as the local ID to uniquely identify a particular commercial product, service, and the like that pertains to a particular article of a particular informational printed material 411B, such that the commercial item ID is readable from the outside.

### Bookmark (Physical Bookmark) of Commercial Item as Physical Medium

Upon a request from an information viewer terminal 4200C as shown in FIG. 1, an administrator system stores, in a predetermined storage means, an information for bookmarking a specific commercial item related to a commercial item ID that has been read by the information viewer terminal 4200C, while relating the bookimark information to the information viewer terminal 4200C that has read the commercial item ID or to a user that has read the commercial item ID. The bookmark information includes a bookmark title consisting of a title information of the particular commercial item (for example, in case the specific commercial item is a commercial product, it may be a product name thereof) and a bookmark ID for uniquely identifying the particular commercial item (though it may be typically a commercial item ID of the particular commercial item, it may be an URL of a guiding page as a web page of a main information of the particular commercial item). Then, the administrator system enables a user to access directly to the information (typically the guiding page) relating to the particular commercial item corresponding to the bookmark ID, by selecting and executing the bookmark title. (Bookmark Process)

### Physical Bookmark

As described above, in the information providing system of the present invention registers a particular commercial item as a favorite (bookmark) or stores a browsing history thereof, just like the conventional process of bookmarking a specific web page on the World Wide Web (WWW), when an information viewer such as a general consumer or a vendor, reads the local ID of a particular item by the ID reading means of the information viewer terminal 4200C. That is, it is done by reading, to browse a main information of the particular item, the local ID such as a commertial item ID or a node ID or a field ID that is associated (linked) with a physical medium such as a particular commertial item or informational printed maerial or building, which is located at a particular place as a destination to visit where he or she actually visits in a real world, and, in an extreme case. In an extreme case, it is done just by reading the local ID of the commercial item, without browsing the main information through the information viewer terminal 500, while he or she browses an information written on the informational printed material as a physical medium in order to describe the commertial item or the like in a corresponding manner to the main information. Then, based on a bookmark information thereof, the information viewer can select and execute, with a mouse click or the like, to operate a hyperlink to the main information pertaining to the specific commertial item that has been bookmarked. Alternatively, based on the past browsing history of the main information or a past reading history of the local ID, the information viewer can select and execute, with a mouse click or the like, to operate a hyperlink to the main information pertaining to the specific commertial item that has been browsed in the past or that has the local ID read in the past. Thus, the system is configured such that the information viewer can instantly retrieve the main information of the particular commercial item and can access the webpage of the main information. In the present invention, such a bookmark is referred to as a “physical bookmark” in the sense that it becomes a bookmark (bookmarker) that is given to a physical medium such as a commertial item. As mentioned above, the main information of the physical medium such as a particular commercial item can be retrieved on the basis of the browsing history, in addition that it is retrieved through the bookmark. Still, in the present invention, such a case that is based on the browsing history is also referred to as the “physical bookmart”.

### Entire Structure

The information providing system of the first embodiment will be described in detail below. As shown in FIG. 1, the information providing system of the first embodiment is equipped with an administrator system 4100 and a user terminal device 4200. The user terminal device 4200 may be comprised of a user computer device (hereafter “user PC”) 4200A, a user PC 4200B, or a user mobile terminal device (typically a user's smartphone, hereafter “user SP”) 4200C.

In detail, the user terminal device 4200 is configured to realize various functions by an information means 4210 (various functions provided by the information providing system through the function providing means 4115, such as a my memory processing function and a memory service processing function, which will be described below). With respect to these various functions provided at a side of the user terminal device 4200, they may be configured in the user terminal device 4200 as a client device through the function providing means 4115 (e.g., a sever-side program) that the administrator system 4100 provides at a side of a server. For example, is may be configured as an information means 4210A that obtains the functions through a “WEB” in a user terminal device 4200A of FIG. 1. However, it may be configured as an information means 4210B, in the user terminal device 4200 as the client device, that realizes the function by itself through an “app (application)” in a user terminal device 4200B of FIG. 1. The information means 4210, 4210A, and 4210B of the user terminal devices 4200, 4200a, and 4200b respectively include, corresponding to processing functions of the administrator system described later, a memory management means 4211 (that realizes a function corresponding to a memory management function such as a My Memory Processing and a Memory Service Processing), a page management means 4212 (that realizes a function corresponding to a page management function such as a page creation processing), an article management means 4213 (that realizes a function corresponding to an article management function such as an article creation processing), an event management means 4214 (that realizes a function corresponding to an event management function such as an event creation processing), a work management means 4215 and a commercial product management means 4216 (that realize functions corresponding to a work management function and a commercial product management function), a collaboration management means 4217 (that realizes a function corresponding to a collaboration management function such as a collaboration application processing), and a shelf management means 4218 (that realizes a function corresponding to a shelf management function such as an item shelf processing). In addition, the system is equipped with an administrative means 4219 to realize other administrative functions.

### Physical Media Providing Field

In the physical media providing field of the information providing system of the first embodiment, the objects include not only the commercial products (objects) and stores (locations) but also people (creators and the like in addition to the user) and things (events and the like). Therefore, business cards (of creators and the like) may also be a physical media providing field.

### Memory as Local ID

In the first embodiment, a node ID is used as an identifier corresponding to the local ID. A two-dimensional barcode, an NFC tag, or the like may be used as an ID storage medium for storing the node ID. Here, in the first embodiment, the node ID is stored in the ID storage medium including a two-dimensional barcode or the like (hereinafter referred to as a “bookmark” or a “memory” in some case).

### Acquisition of Object Information such as Commercial Product Information through Node ID

In the first embodiment, obtainable is various information about an object (various object information), such as a product information, a geographic information, an article information, and the like, through the same process as obtaining various information by the commercial item ID. Also, in the first embodiment, the same processings (realizing the functions) as the bookmarking means and the like, can be performed through the memory.

### Overview of Structure, System Target, and Operation of Present Information Providing System

As shown in FIG. 1, the information providing system of the first embodiment is equipped with an administrator system 4100, a user system 4200, a physical media providing field 4400, and a web server 600. The information providing system of the first embodiment is characterized in that the users (user) of the user terminal device 4200 include individuals, creators, event promoters, shopkeepers, advertising media providers, etc., in addition to users such as business operators. In particular, the information providing system of the first embodiment is characterized in that the individuals such as general consumers can also use the system for themselves. Moreover, the information providing system of the first embodiment is characterized in that various processes described below are performed by use of My Memory (sometimes abbreviated to “MM” in the present application documents), which is an ID storage medium corresponding to a bookmark.

### Overview of Information Management Means of Administrator SYS

As shown in FIG. 1, the administrator system 4100 is equipped with an information management means 4110. The information management means 4110 realizes a function of managing various information, such as information provided to the user terminal device 4200. The administrator system 4100 also has a management information database (hereafter referred to as “Management Information DB”) 4120. The management information DB 4120 realizes, in collaboration with the information management means 4110, a function of storing various information such as a main information provided to the user terminal device 4200. A management screen 130 of the administrator system 4100 displays a user interface (GUI) for managing the aforementioned various information. A person in charge can manage the various information through the management screen 130.

### Details of Information Management Means of Administrator SYS

As shown in FIG. 1, the information management means 4110 of the administrator system 4100 is equipped with a node management means 4111, an edge management means 4112, a service management means 4113, a data management means 4114, and a function providing means 115. Moreover, although not shown, the information management means 4110 has a configuration (function realization means) for realizing various processing functions in conjunction with the management information DB 4120.

### Node Management Means

The node management means 4111 refers to data of a node table (and, in the case of processing for a registered user, a user table) and so on, which will be described below, so as to realize functions of generating a new node (i.e., a new node table) and updating the node table, while realizing functions of setting a node type for each node ID in the node table, and other functions. That is, the node management means 4111 is a function realizing means for realizing a variety of processing functions that are related to the nodes.

### Edge Management Means

The edge management means 4112 refers to data of the node table and an edge table described below, so as to realize a function of generating an edge for forming a link between some one node (a first node) and another one node (a second node), based on a reading operation of a memory (and based on an ID information corresponding to the memory that has been read). Then, as described below, the edge management means 4112 realizes functions of generating a data structure of a subject/predicate/object relationship and updating the edge table, while realizing functions of setting an edge type for each edge in the edge table, and other functions. That is, the edge management means 4112 is a function realizing means for realizing a variety of processing functions that are related to the edges.

### Service Management Means

The service management means 4113 is a function realization means for realizing processes that are related to various services, by referring to data of the node table and the edge table and the like.

### Data Management Means

The data management means 4114 is a function realization means for realizing functions such as adding/creating/editing/deleting various types of data, by referring to the data of the node table, the edge table and the like.

### Information Management Database of Administrator SYS

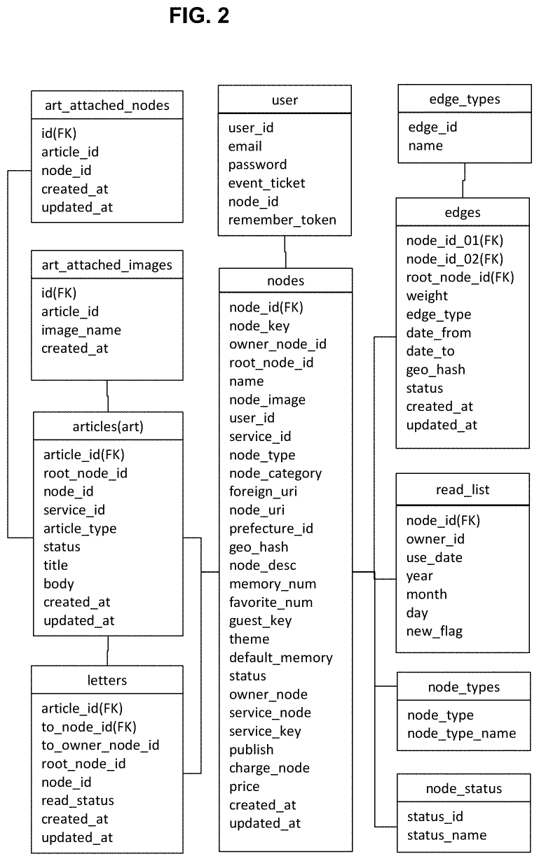

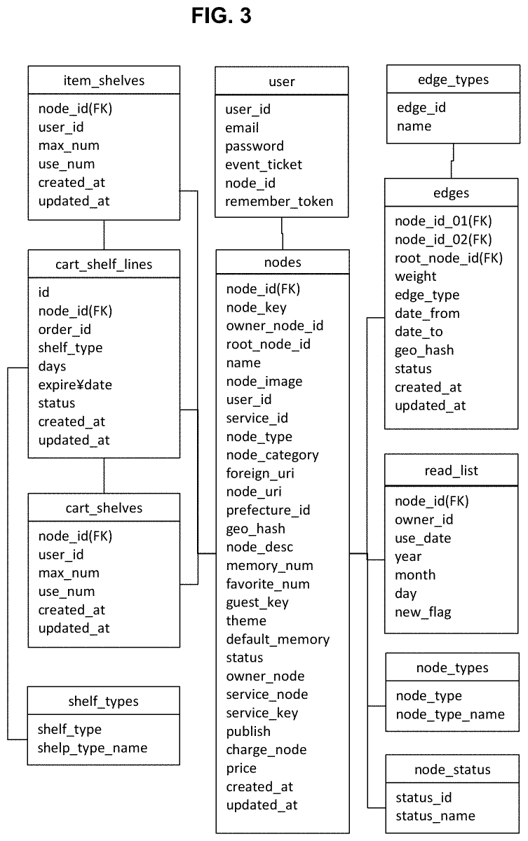

The management information DB 4120 may be configured by a relational database (RDB). In this case, as an example, the management information DB 4120 may be configured such that it has a data structure (data schema) as shown in FIG. 2 and FIG. 3. In detail, in the case of the example shown in FIG. 2 and FIG. 3, the management information DB 4120 has, as master tables, a node type table (node_types), an edge type table (edge_types), a shelf type table (shelf_types), a sequence table (sequences) and so on. The node type table stores a node type (node_type), which is a data defining a type of a node, while associating the node type with a node type name (node_type_name). The sequence table stores an order ID (order_id) and a node ID (node_id) and a user ID (user_id), which are used in tables for a billing process (not shown), in a related manner.

In addition, the management information DB 4120 includes, as transaction tables, a node table (nodes), a node status table (node_status), an edge table (edges), a user table (user), a read list table (read_list), an article table (articles), a letter table (letters), an article attachment node table (article_attached_nodes: “art_attached_nodes” in FIG. 2), and an article attachment image table (article_attached_images: “art_attached_images” in FIG. 2), an item shelf table (item_shelves), a cart shelf table (cart_shelves), and a cart shelf line table (cart_shelf_lines). Although not shown, the management information DB 4120 also has a table for storing data for paid services, while associating the table with a billing-related table. In addition, the management information DB 4120 may also have a browsing history table and so on.

### Node Table

The node table (nodes) is a table for storing and managing node IDs and related information thereof for each memory. The node table is a table corresponding to a node table of a second embodiment. The node table includes, as field names (columns or column names), a node ID (node_id), a node key (node_key), an owner node ID (owner_node_id), a root node ID (root_node_id), a node name (name), a node image (node_image), a user ID (user_id), a service ID (service_id), a node type (node_type), a node category (node_category), an external URI (foreign_uri), a node URI (node_uri), a prefecture ID (prefecture_id), a geohash (geo_hash), a node description (node_desc), a node start date (node_date_from), a node end date (node_date_to), a memory number (memory_num), a favorite number (favorite_num), a guest key (guest_key), a theme (theme), a default memory (default_memory), a state (status), an owner node (owner_node), a service node (service_node), a service key (service_key), a publishment (publish), a charge node (charge_node), a price (price), a created date (created_at), an updated date (updated_at), and a rejection number (reject_num). The node table stores each of values of the avobe-described ones in the field to which each of the records (each of the tupples) corresponds, while associating each of the values with each other. The node table may be configured such that it further stores other data, as necessary.

The node ID of the node table is a unique identifier (ID) that is given to each specific object as a local ID, as described above. The node ID can be configured arbitrarily. In the present information providing system, a guest user (who have not yet accessed the present information providing system) is allowed to read a memory for guests consisting of a two dimensional barcord or the like (e.g., a two dimensional barcode that is displayed on an introductory flyer or introductory web page of the present information providing system), which is issued by the administrator ystem 4100 to enable an access for a guest by use of a camera function and an ID reading function of his/her own smartphone. Thus, the guest user is enabled to log in as a guest user to the present information providing system. With respect to the memory for the guest, the web page to which the guest user accesses (the web page that is displayed on the smartphone of the guest user), is a web page at the time of login (so-called landing page) that the information providing system has prepared in advance. The landing page is also processed as a node in the present information providing system. Thus, the landing page has a node ID that is unique to the landing page, too. At this time, since the guest user does not have hes/her own node (i.e., he or she does not have a node table), a node proper to that guest user is created by the present information-providing system (using the node management means 4111 and other means of FIG. 1). Then, the present information-providing system assigns a unique node ID to that node. This node ID is an ID that consists of sequential numbers (that is easily guessed by others). Accordingly, the node key is a key that is uniquely assigned to this node ID (i.e., a key that complicates the node ID by hashing or other means), taking into account cases where the information is supplied externally.

Next, when a guest user completes a registration process as a registered user through a user registration process of the present information providing system, there is created a user table for storing a user information of the guest user, while the user table being associated with the node table of the guest user. Though details of the user table are described later, the user table stores the node ID of the user that has been stored in the node table. Thus, when the user accesses and logs in to the present information providing system in the next time, the present information providing system obtains the data of the node table of the user via the node ID of the user table so as to perform the login process for the user. That is, at this time, the present information providing system refers to the node table indirectly (via the user table) by checking a user ID (or an email address) and a password that are entered by the registered user against a user ID (or an email address) and a password stored in the user table.

On the other hand, if the guest user does not execute the user registration process of the present information providing system, no user table is created for the guest user. Even in this case, the guest user has his/her own node at this point (i.e., a node table proper to the guest user has been created). Still, the next time the guest user accesses and logs in to the present information provisioning system, there is no user table of the guest user in the present information providing system. Thus, the present information provisioning system cannot execute the same login process as the registered user, by using the node ID. Accordingly, for purpose of such time, when the guest user first accesses the information providing system (i.e., in response to a request at the time of the first access), the present information providing system stores, (utilizing the node management means 4111 or the like), a guest key into a cookie of a response by use of an existing cookie technology. Thereby, when the guest user accesses and logs in to the present information providing system in the next time, the present information providing system executes a similar login process as the registered user, by using the guest key stored in the node table. That is, a request of the guest user (at the time of access) has a guest key unique to the guest user stored in the cookie (as long as the guest user permits the cookie, and if the cookie has not been erased due to an expiration of a retention period thereof or other reasons). Thus, the present information providing system checks the guest key in the request against the guest key stored in the node table of the guest user, thereby referring to the node table where the guest key is stored (i.e., the node table storing the node of the guest user). Finally, the present information providing system executes the similar login process as the registered user through the node ID.

As described above, there are provided a login process as a guest user and a login process as a registered user, as modes of the login process to the present information system. In case of the guest user, the guest user directly accesses the node table of the guest user via the guest key. In the case of the registered user, the registered user indirectly accesses the node table of the registered user via the node ID of the user table. That is, the present information providing system identifies whether the user accessing the system is a guest user (without a user table) or an owner (owner user) as a registered user (with a user table), depending on whether or not a user table exists for the user accessing the system.

With respect to the owner node ID, the value of the node ID (that has been created when the user accessed the system for the first time) is stored in the owner node ID (in the sense that it has become the node ID of the user who is the owner of that node) the next time when the user accesses and logs in to the present information providing system (i.e., the node ID becomes the owner node ID). As described above, an owner with an owner node (guest user or registered user) can generate his or her own another self (owner node), which is a substantive entity in the physical world (physical existence), in the virtual world on the network (that is realized by the present information providing system). The owner is allowed to own only one owner node that is a special node. At this time, the value of the owner node (flag) in the node table is changed from “0” (indicating that the node is not yet the owner node) to “1” (indicating that it has become the owner node). A guest user is allowed to have only the one node in the same way as a registered user.

Thereafter, when the user who owns the owner node records a memory of an other node at some location (e.g., a node that corresponds to a memory attached to a particular commercial product located in a particular store), the owner node of that user (hereinafter sometimes referred to as a “primary node”) becomes a subject, while the other node (hereafter sometimes referred to as a “secondary node”) becomes an object. Then, these primary node and secondary node are linked (associated) by an edge (that is defined in the edge table described below). At this time, that edge becomes a predicate that connects the subject and the object. That is, the present information providing system is capable of defining any event or object that can be represented by a subject, a predicate, and an object by forming a link between one node and another one node with a single edge, by use of the node table and the edge table. That is, in the information providing system of the first embodiment, the node table is configured as a self-referential table. Thus, by using only the node table and the edge table, the nodes are linked to each other with the edge, while the relationship between them can be expressed in terms of a relationship of the subject, the predicate, and the object.

The root node ID is an ID indicating that it is a node of a highest level hierarchy (root hierarchy) when there is a hierarchical memory structure. For example, suppose that there is a memory representing an internet shop (e.g., the user owns the memory of the internet shop) and, at the same time, there are memories of commercial products sold in that internet shop (e.g., if the user owns the memory of the internet shop). Then, the node ID of that internet shop becomes the root node ID (in the sense that the node becomes the root node of the nodes of the commercial products). For example, suppose that a customer of an internet shop sends a “letter” to another online store owned by some user or to the nodes of the commercial products sold in that online store (which is a notice of an “article” discussed below). Then, it is configured such that that letter is not sent to the node of that commercial product, but directly to the node of that online store through the root node ID of the node of that online store to which that commercial product belongs (i.e., referring to the root node ID of that node table on the basis of the node ID of that commercial product). At this time, in the hierarchical structure, there is an owner node situated at a still upper level than that online store. In this case, the letter is sent directly to the owner node based on the owner node ID in the node table (not to the node of the online store).

The node name is an arbitrary string of characters that are assigned to that node. The node image is an image (image), which is assigned to that node, (and that is displayed as a thumbnail or the like on a display screen for that node). The user ID is a unique ID of the registered user that is stored in the user table.

The service ID is an ID that is uniquely assigned to each of the various services that are provided by the present information providing system. In other words, the present information providing system is a service providing system that provides various services in a holistic/integrated manner.

The node type is an ID for identifying the type of the node. The node category is an ID for identifying the category of the node. For example, the node category is the one that identifies a category (classification) such as a self (e.g., owner), a “people” (e.g., creator), a “thing” (e.g., event), an “object” (e.g., commercial product), and a “place” (e.g., online shop). On the other hand, the node type is the one that identifies the clss of the node by subdividing it more than the node category. For example, a commercial product (e.g., node A1) of an online shop (e.g., node A) and a work (e.g., node B1) of a creator (e.g., node B) belong to the same category as the “thing” in the node category. However, the node type is configured such that, for example, the commercial product belongs to a “(shop's) commercial product”, while the work belongs to a “(creator's) work”. That is, the node type is used to identify what that “thing” specifically is (e.g., whether it is a creator's work). Thus, the node type is the one that subdivides the category.

The external URI stores “0” or “1” as a flag. The external URI is set to “1” if an information page of that node is identified by an external URI (rather than an internal URI provided in the present information providing system). The external URI is set to “0” if the information page of the sane node is an internal URI of the present information providing system. If the external URI is set to “1” (only if it is “1”), then the node URI is used. At this time, the external URI is stored in the node URI.

The node start date (though not shown in FIG. 2 and FIG. 3) identifies a start date of the node in case the start date is set to the node. The node end date identifies an end date of the node in case the end date is set to the node.

For example, suppose that an expiration date is set to the node (e.g., a particular product is displayed on a shelf that is defined in a shelf-related table described below, while its display period is limited (e.g., set to 60 days)). Then, the display period (e.g., 60 days) is counted down from a use start time when the shelf was started to be used by the commercial product (i.e., the display start time of the commercial product by using a display function for the commercial product). In this case, the value is stored only at the node end date, but this depends on the contents of the shelf (in the shelf-related table).

The memory count is a number of people (headcount) who have recorded the node (by the memory). The favorite is a number of people (headcount) who additionally have bookmarked the node (by the favorite). The theme allows a change of the theme of the information page of the node with CSS and so on. The default memory is a name of the memory (e.g., a two-dimensional barcode or the like) that is generated by default. That is, when a node is created for the first time in the present information providing system, a unique memory (such as a two-dimensional barcode) is created by default. However, the default memory is a name of the memory like the two-dimensional barcode and so on at this time. The default memory is uploaded to the network via the cloud or the like and is stored as an image tag.

The state is a value that represents a state of the node. The state stores values such as “0”, “1”, “2” and so on. For example, the state is set to “0” when the node is unusable, while being set to “1” when the node is a guest user, and while being set to “−1” when the node is to be deleted.

The owner node is set to “0” when the node has not yet become an owner node, as described above, while it is set to “1” when the node has become an owner node. The service node is a flag that identifies whether the node is a node that belongs to a service or not. The service node is set to “1” if the node is to be a service, such as an internet shop or a place. The service node is set to “0” if the node is not to be a service, such as a commercial product and the like. The service key is a separate key from the node key. The service key is published to the outside world by means of a two-dimensional barcode or the like. For example, the service key is composed of 40 random rows of values. This service key is a key for the memory that is provided for identifying a menu supplied by the present information providing system. That is, in this information-providing system, the owner is allowed to own various services in connection with the owner node, while being allowed to publish the services to the outside world together with the memories thereof. Still, in order to prevent the key of the menu from being known to the outside world, the service key is provided as a key for the outside world.

The publishment (publish) is a flag that specifies whether the node is public or private. The publishment is set to “1” if it is used for the public, while being set to “0” if it is used for the private. The charge node is used in case a billing occurs. The price is used to store a price in case the billing occurs.

The created date stores a created date (date and time of creation) of the node. The updated date stores an updated date (date and time of update) of the node. The rejection number is a number of people (headcount) who have chosen not to receive the letter from that node. The rejection number is a total number of the people (nodes) who have rejected the letter from that node. By referring to the rejection number, it is possible to determine which person (which node) is rejecting the letter (based on the node ID or the like of the node to which the rejected letter is to be sent). The above-mentioend state (status) is explained in relation to the edge table. That is, it is configured such that, when the state (status) of a particular destination node is “0”, the node cannot send a letter to that particular node.

### Node Type Table

A node type table is a table that defines a type of a node in the node table. The node type table has, as filed names (vertical raw names or column names), a node type (node_type) and a node type name (node_type_name). The node type table stores each of values thereof in each of fields corresponding to each of records (each of tuples) thereof. The node type representes a “person” and the like, as described above. The node type name is a name that is attached to the node type.

### Node State Table

A node state table is a table that defines a state of a node in the node table. The node state table has, as field names (vertrical raw names or column names), a state ID (status_id) and a state name (status_name). The node state table stores each of values thereof in each of fields corresponding to each of records (each of tuples) thereof. The state ID is an ID that uniquely represents the state of the node. The state name is a name that is assigned to each of the state IDs.

### User Table

A user table is a table that stores a registration information of a user. The user table has, as field names (vertica raw names or column names), a user ID (user_id), an email (email), and a password (password), just as in general user tables. The user table stores each of values thereof in each of fields corresponding to each of records (each of tuples) thereof. Moreover, the user table has, as its own data, an event ticket (event_ticket), a node ID (node_id), and a memory token (remember_token). The user table stores each of values in each of fields corresponding to each of records (each of tuples) thereof. The event ticket is a datum about a ticket for purchasing an event. The node ID is the node ID of the above-mentioned node table. The memory token is a datum for a login of a guest user.

### Edge Table

The edge table corresponds to a link table of a second embodiment. Moreover, the edge table is, like the link table, a table that further stores a descriptive information for expressing the aforementioned relationship of the subject, the predicate, and the object, in addition to a link information forming a link between one node (first node) and another one node (second node). The edge table has, as field names (vertical raw names or column names), a node ID1 (node_id1), a node ID2 (node_id2), a root node ID (root_node_id), a weight (weight), an edge type (edge_type), a start date (date_from), an end date (date_to), a geo hash (geo_hash), a state (status), a created date (created_at), and an updated date (updated_at). Each of values thereof is stored in each of fields corresponding to each of records (each of tuples) thereof.

The node ID 1 is a node ID of one node (the first node), while the node ID 2 is a node ID of another one node (the second node), in case that a link is formed by an edge (e.g., between the first node and the second node, as described above). The root node ID is as described with respect to the node table. The weight is equivalent to a link strength in the second embodiment. The weight represents a link strength between the one node and the other node. In the first embodiment, the weight is configured as follow. For example, in case a user of some owner node records a memory of another node (e.g., a memory of a commercial product), the weight of the edge linking the owner node to the node of the commercial product is “1” at the time of the recording. However, if that owner subsequently registers the memory of the commercial product as a favorite, the weight of the edge between the owner node and the commercial product node is incremented to “2”. Alternatively, for example, in case a user of an owner node records a memory of a creator node, which is another node, the weight of the edge linking the owner node and the creator node is “1” at the time of recording. However, if a collaboration request (described below) is made thereafter from the creator node to the owner node and if the owner accepts the collaboration request, the weight of the edge linking the owner node with the creator node is incremented to “2”.

The edge type identifies and expresses attributes of the edge that functions as a predicate as described above. For example, the edge type is composed of a recording (memory) (that is to be an attribute in case of recording various types of memories), an owning (have) (that is to be an attribute in case of owning an internet shop node and the like), a holding (hold) (that is to be an attribute in case of holding an event and the like), (have), and (have). (an attribute of a specific role in an event, etc.), an acting (that is to be an attribute in case of playing a specific role in an event and the like), and a participating (that is to be an attribute in case of becoming a participant in an event and the like), and so on. As the edge types, any edge type may be used as long as the edge functions as a predicate. A wide variety of attributes may be stored as the edge types.

The start date stores the date (date and time) when the edge was generated. The end date stores the date (date and time) when the link by the edge ends. The start date and the end date are provided for each of the edges. Moreover, the relation (edge type) between the nodes, which is defined by the edge, is not limited to the memories (memory). That is, if the edge has an expiration date, i.e., if the edge is only valid from a certain time point to a next certain time point, a date and time thereof is stored in the start date and the end date. For example, suppose a case in which a certain node (first node) stores a record (memory) of another node (second node) and in which there is a contractual relationship between the first node and the second node (i.e., a case in which there are a first edge and a second edge as edges linking the first node to the second node, wherein the first edge shows that the first node has recorded the second node (i.e., the first edge having an edge type of “record”), while the second edge shows that there is a contractual relationship between the first node and the second node (i.e., the second edge having an edge type of “contract”). In such case, the system may be configured as follows. That is, if an expiration date (contract period) is set for the contract, this contract period is stored as defined by a start date and an end date of the second edge (or stored as defined only by the end date). Then, after the expiration of the contract period, the link by the first edge between the first node and the second node does not disappear in itself. However, the link by the second edge between the first node and the second node is broken (i.e., defining the termination of the contract). That is, the start date and the end date are used to establish a validity period on a link side for the predicate (edge) that connects the subject (first node) to the object (second node).

The geohash is the one that is similar to the geohash of the node table. The geohash of the node table shows the location of the node itself. The geohash of the node is “null” if the geohash has not yet registered. Moreover, in the case of the geohash of the node table, for example, if a memory is sent to a shop, a location information of the shop at the location where the memory was sent (the destination) is stored. Thus, a location information that is different from the location information of the source, is stored. Since the details of the created date and the updated date are the same as the created date and the updated date of the node table, their descriptions are omitted.

### Edge Type Table

The edge type table is a table that defines the types of the edges in the edge table. The edge type has an edge ID (edge_id) and a name (name) as field names (vertical raw names or column names). The edge type stores each of values in each of fields corresponding to each of records (each of tuples).

The edge ID is the edge ID of the edge table. The name (edge name) is a name uniquely attached to the edge ID.

### Memory Recording Process

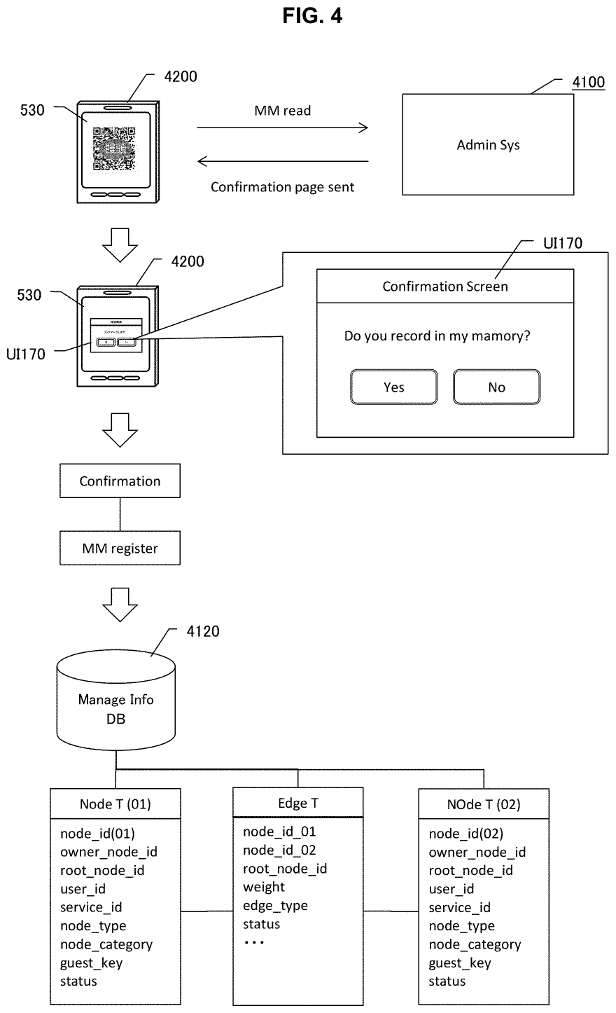

A memory recording process with the information providing system of the first embodiment will be described with reference to FIG. 4. First, suppose that an information viewer such as a traveler is interested in a particular commercial product 410A in a store that is located at a visited destination such as a travel destination, and that he or she wishes to purchase that commercial product 410A at a later date. Alternatively, suppose that an information viewer such as a traveler is interested in a guiding informational printed material 410A such as a particular tour guiding information or a particular cooking recipe (or an informational printed material 410B that is printed with one or more guiding information) and then wants to view that guiding information later at a tourist information center that is located at a visited destination such as a travel destination. In these cases, as shown in FIG. 3, that information viewer reads a physical ID (i.e., the memory) of the ID medium 411, 411a of that commercial product 410A or that guiding informational printed material 410A (or the informational printed material 410B) by use of the user terminal device 4200 (ID Reading Process). Then, there is displayed a memory recording page UI170, as shown in FIG. 4, on a viewing screen 530 of the user terminal device 4200 (Confirmation Screen Display Process). Here, the process of displaying the confirmation screen in the memory recording page UI170 on the user terminal unit 4200, is the same as the bookmarking process in an eighth embodiment.

Next, in the above confirmation screen display process, the information viewer executes a selection execution process (i.e., clicking a “Yes” button or the like) in order to confirm that a memory thereof is to be recorded on the memory recording page UI170. Then, the user terminal unit 4200 sends data consisting of a node ID thereof that is unique to the memory of that commercial product 410A or the like, a user ID thereof (in case of a registered user) or a guest key thereof (in case of a guest user) of that information viewer, a browsing time, and so on. The data is sent to the administrator system 4100 by using a predetermined transmission method such as the Post method of the HTTP.

### (Browsing Data Transmission Process)

Thereby, the node ID of the node allocated to the newly recorded memory is stored in the node table of that user. At the same time, an edge information that links the node (first node) of that user with the node (second node) of the recorded memory, is stored in the edge table of that user. Consequently, there is generated a data structure between the first node and the second node that is represented by the subject/predicate/object relationship described above through the edge.

### Initial My Memory Reading Process

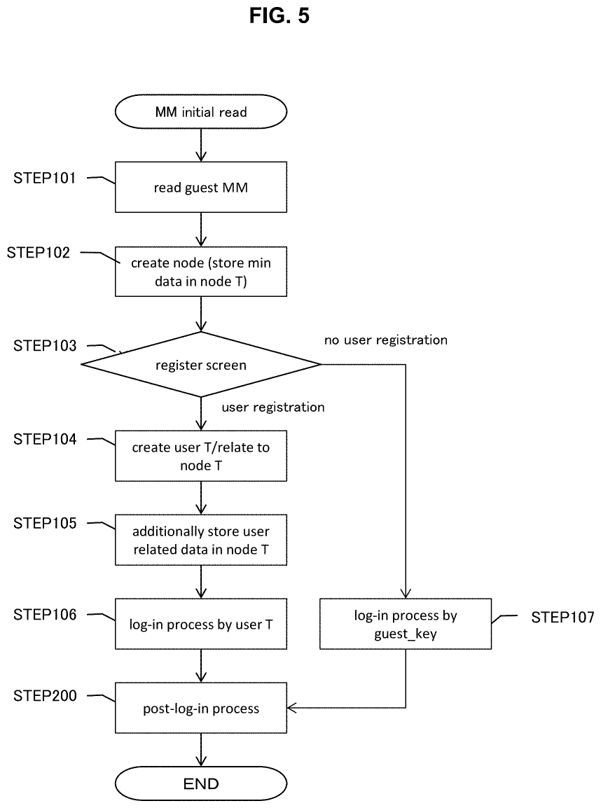

A flowchart in FIG. 5 is used to illustrate a login process by a first memory in the above-mentioned my memory process (process at the time of an initial access by the guest memory). First, as shown in FIG. 5, in STEP 101, suppose a person who has not yet used the information providing system (i.e., a non-registered user and, at the same time, a person who has never accessed the information providing system even as a guest user, that is, a “guest user”). When he or she reads a memory for an initial access (the aforementioned memory for guest) by a smartphone or the like, a node (i.e., a node table) is created for that guest user in STEP 102. Then, the minimum datum/data is/are stored in the node table (datum/data that is/are required for a next login, i.e., datum/data such as a guest key and the like). Next, in STEP 103, the guest user selects whether or not to register as a user. If he or she selects to perform a user registration process, in STEP 104, a user table for that user is created. In this process, that user table is related to the node table of that user. Then, in STEP 105, related data (such as a user ID and the like) of that user table is additionally stored in that node table. Thereby, that user (registered user) is authorized to access the node table and log in to the information providing system in the next time and in subsequent times, in STEP 106, through the user table, as described above. On the other hand, if the guest user does not perform a user registration process in STEP 103, a user table for that user is not created. Then, that guest user is authorized to log in to the information providing system in the next time and in the subsequent times, in STEP 107, by directly accessing the node table by use of the guest key as described above. In either case, after such process, the user is authorized to move on to a post-login process in STEP 200.

### Post-Login Process

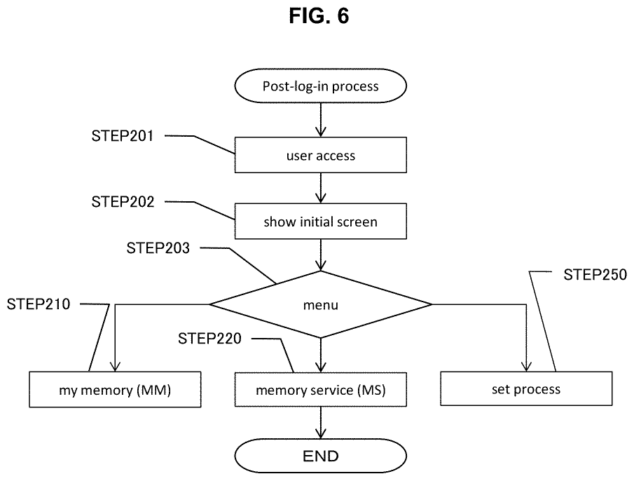

A flowchart in FIG. 6 is used to illustrate the above-mentioned post-login process. First, as shown in FIG. 6, when a user accesses the information providing system in STEP 201, an initial screen specific to that user is displayed in STEP 202, by the system referring to the node table and the like of that user. Next, in STEP 203, the user is allowed to select which processes of a menu to be performed. Then, he or she is allowed to exectute the aforementioned my memory process (STEP 210), the aforementioned memory service process (STEP 220), and a setting process (STEP 250) such as a changing of a user name and a password and so on.

### My Memory Process

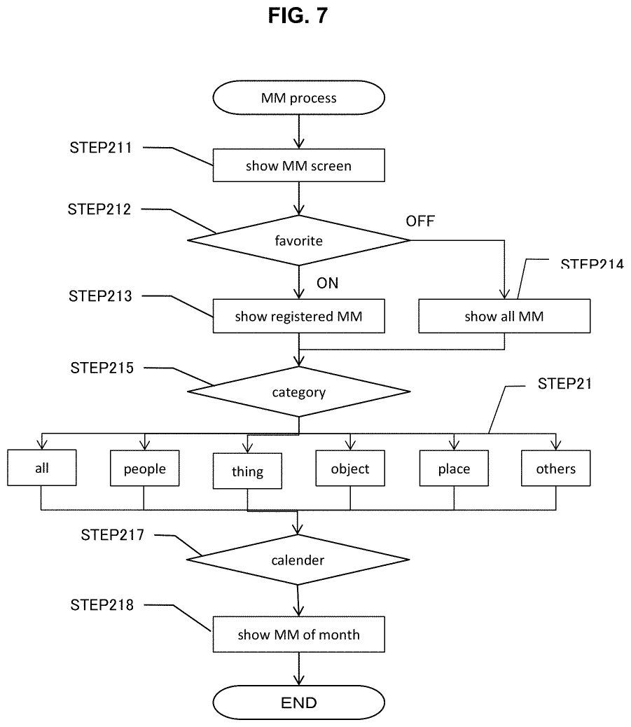

A flowchart in FIG. 7 is used to illustrate the above-described my memory process. First, as shown in FIG. 7, a my memory screen that is proper to the user is displayed in STEP 211. Then, the user is allowed to select (in the manner as described above), in STEP 212, whether or not to display only the memory/memories that has/have been registered as the favorite/favotrites, among the my memories of that user. If the user chooses to display only the memory/memories that has/have been registered as the favorite/favotrites, only the memory/memories that has/have been registered as the favorite/favotrites, are displayed on the my memory screen in STEP 213. On the other hand, if the user chooses to display all of the memories, all of the memories are displayed on the my memory screen in STEP 214. Subsequently, the user is allowed to perform a selection/display process for each of categories of the memories in STEP 215. Then, in STEP 216, the user is allowed to select one of the categories among “All”, “People”, “Things”, “Objects”, “Places”, and “Others” so as to display only the memory/memories kept in that category. In addition, the user is allowed to select whether or not to perform the aforementioned calendar process in STEP 217. In case of perfotming the calendar process, the user is allowed to display the my memory/memories for the selected month in STEP 218, as described above.

### Memory Service Processing (Creation

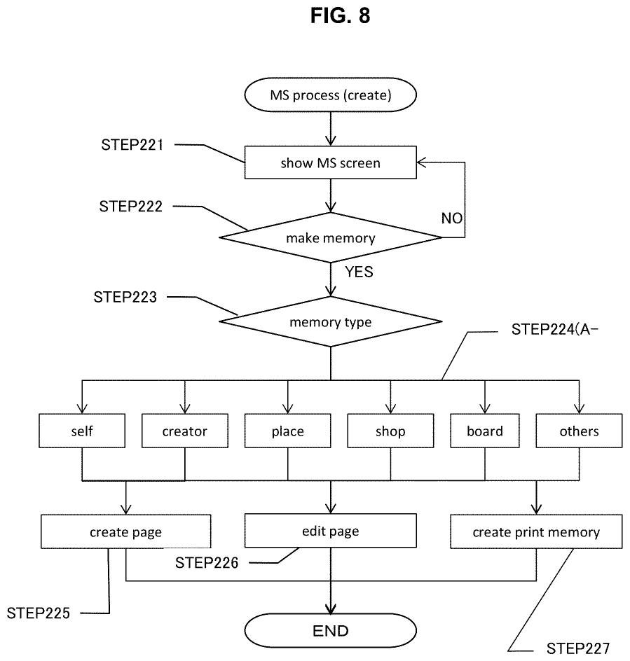

The flowchart in FIG. 8 is used to explain a process in case of creating a new memory (memory creation process) among the above-mentioned memory service processes. First, as shown in FIG. 8, a memory service screen that is proper to the user, is displayed in STEP 221. Then, the user is allowed to select whether or not to create a new memory in STEP 222. Thereafter, in STEP 223, the user is allowed to select a type (category) of the memory to be created. Subsequently, in STEP 224A-F, the user is allowed to execute a creation process for each of the categories of the memories. Thereafter, the user is allowed to execute, for the created memory, the above-described page creation process (STEP 225), the above-described page editing process (STEP 226), and the above-described printing memory creation process (STEP 227).

### Memory Services Processing (Management)

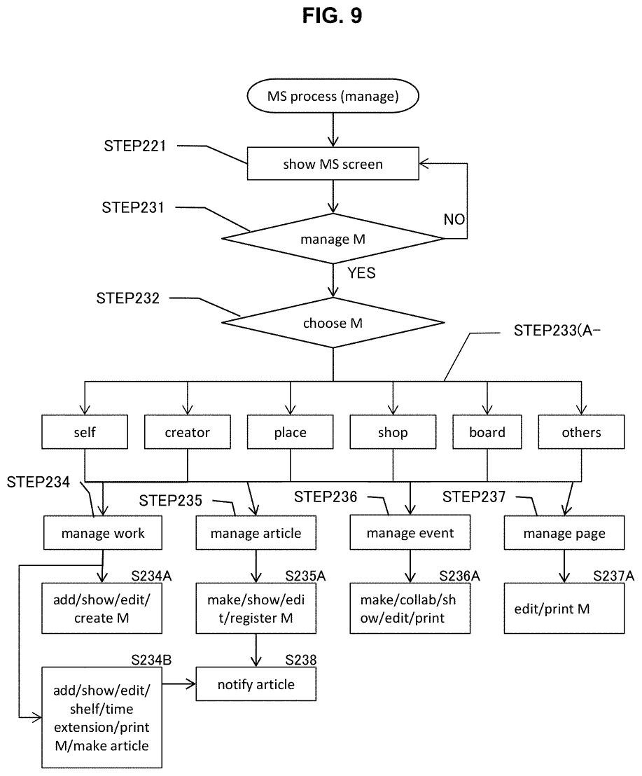

The flowchart in FIG. 9 is used to illustrate a management process for the created memory (memory management process) among the above-mentioned memory service processes. First, as shown in FIG. 9, a memory service screen that is proper to the user, is displayed in STEP 221. Then, in STEP 231, the user is allowed to select whether or not to perform a memory management processing for the created memory. Therafter, in STEP 232, the user is allowed select the memory for which the memory management processing is carried out. In STEP 233A-F, the user is allowed to perform the management process for each of the categories of the memories. That is, the user is allowed to execute, for each of the memories, the aforementioned work addtion process or the product management process (STEP 234), the aforementioned article management process (STEP 235), the aforementioned event management process (STEP 236), the aforementioned page management process (STEP 237). Moreover, as described above, the user is allowed to perform, as processes that depend on them, a first subordinate process 234A, a second subordinate process 235A, a third subordinate process 236A, a fourth subordinate process 237A. The first subordinate process 234A consists of an addition process of works/products, a display process of works/products, an editing process of works/products, a memory creation process of works/products, and so on. The second subordinate process 235A consists of an article creation, an article display process, an an article editing process, a memory registration process, and so on. The third subordinate process 236A consists of an event creation, a collaboration application process, an event display process, an event editing process, a printing memory creation process, and so on. The fourth subordinate process 237A consists of a page editing process, a printing memory creation process, and so on. Furthermore, the user is allowed to perform, as processes that depend on the works/products management process, a fifth subordinate process 234B. The fifth subordinate process 234B consists of an addition process of works/products, a display process of works/products, an editing process of works/products, an inventory process of works/products, a time extension process of works/products, a printing memory creation process of works/products, an article creation process, and so on. In addition, the user is allowed to perform, as a process that depends on the second subordinate process 235A or the fifth subordinate proess 234B, an article notification process (letter transmission process) S238.

### Subject/Predicate/Object Data Structure with Nodes and Edges

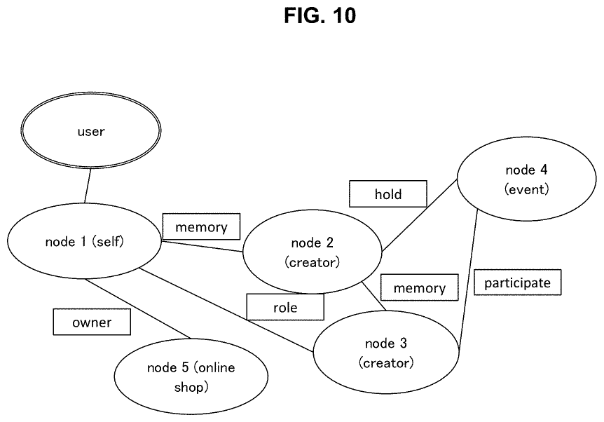

Next, the network diagram of FIG. 10 is used to describe, in an illustrative manner, a data structure of subject/predicate/object by the nodes and the edge as described above. First, suppose that a node 1 of “myself” is registered, as a node belonging to a particular user, in the administrator system 4100. In this case, if that user records the memory of another node 2 (a node of a creator who is the other person), the node 1 and the node 2 are linked by an edge (“memory” that means “record”). That is, there is generated a data structure having such a meaning or a context that “I record another creator or other creators”. Moreover, when that user records a memory of his or her own node 3 (a node where he or she is a creator), the node 1 and the node 3 are linked by an edge (“role” that means “persona”) with each other. That is, there is generated a data structure having such a meaning or a context that “I play a role as a creator”. On the other hand, if the user of the node 2 as the other person records, in the memory, a node 4 of an event that he or she is organizing, the node 2 and the node 4 are linked by an edge (“hold” that means “to hold”) with each other. That is, there is generated a data structure having such a meaning or a context that “Another creator will hold the event”. Moreover, if the user of the node 1, as the creator of the node 3, records the memory of that event of the node 4 in order to participate in the event at the node 4, the node 3 and the node 4 are linked by an edge (“participate” that means “participation”) with each other. That is, there is generated a data structure having such a meaning or a context that “I, the creator, participate in another creator's event”. If the user of the node 1, as the creator of the node 3, records the memory of the creator of the node 2, the node 3 and the node 2 are linked by an edge (“memory”) with each other. That is, there is generated a data structure having such a meaning or a context that “I, the creator, records another creator”. Moreover, if the user of the node 1 opens a new online store and creates a node 5 for that online store and then records a memory thereof, the node 1 and the node 5 are linked by an edge (“owner” that means “to own”). That is, there is generated a data structure having such a meaning or a context that “I own an online store”. In this way, one node having a particular attribute (node type) and another node having a particular attribute are linked by an edge having a particular attribute (edge type). Consequently, there are generated subject/predicate/object data structures that have different meanings and contexts in accordance with each of those attributes.

### Data Representation by Subject/Predicate/Object Relationship

The information-providing system of the first embodiment is capable of build a relation between the one object (the first node) and the other object (the second node) as a representation of a data structure by the subject/predicate/object relationship, by using the nodes uniquely identified in the node table and the edge uniquely identified in the edge table. On the other hand, the linked open data that have been proposed in recent years are not sufficient in terms of practicality due to their strict specifications. However, according to the information-providing system of the first embodiment, it is possible to link the data (between the nodes) together in a relationship that is lighter than these linked open data. Moreover, according to the information providing system of the first embodiment, the type of the edge (edge type) that becomes a predicate, may be arbitrary. Thus, by greatly increasing the types of the edges, the relationship between the nodes can be expressed in various ways as the “subject/predicate/object” relationship. This kind of data representation with the “subject/predicate/object” relationship corresponds to a data representation that is called “triple” in RDF (Resource Description Framework), However, the RDF requires a very strict specification and is not fast enough, which is still insufficient in terms of practicality. In contrast, according to the information providing system of the first embodiment, the relationship between the data (between the nodes) can be represented by using the system that is simpler and lighter than the above-mentioned triple. Thus, the present information providing system can greatly improve the utility.

### Memory Type

The memory becomes a different node in accordance with each type. For example, in the case of the event memory, the memory becomes a node of an organizer, a node of a promoter, a node of an organizer, a node of a participant, etc. of an event (e.g., a trade show, an exhibition, a concert, a seminar, etc.). At last, they are linked to each other by an edge to represent their respective subject/predicate/object relationships. In this case, the nodes are connected (linked) with each other by the edge. However, at this time, a different kind of edge type, as an attribute, is associated with each of the edgesin the edge table that stores the information about the edges. Thereby, the relationship between the nodes will change as the edge type changes.

### Relationships between Nodes

When a certain memory is bookmarked, a node (node) of that memory is created and stored in the node table of the database, while the node being related to its node ID and the like. For example, when a certain user logs in to the web page for user registration in the administrator system and executes the registration process, a node for that user is created (as an owner node).

### Owner Node (Flag)

The owner node (owner_node) is set to “0” before the user logs in. The owner node is set to “1” when the user logs in for the first time so as to be connected to the information providing system (more precisely, when the user reads out the memory for the first time and the connection to the administrator system is successful,and, thereafter, the initial screen is displayed).

### Ege Type

As the edge types, there are a record (memory), an owner, a creator, a promoter, an organizer, a participant, and so on.

### Node Table

The node table is a self-referencing table. The node table has all the relationships aggregated therein.

### Functions and Effects of Information Providing System of First Embodiment

As described above, the information providing system of the first embodiment utilizes various types of memories corresponding to physical bookmarks in order to bookmark the real world (real universe). Thereby, the present information providing system is able to solve a variety of conventional problems as show below. That is, in the past, there are problems related to promotion of sales of commercial products of retail stores such that: it was difficult to build a relationship with consumers before the consumers learned more about their stores and their commercial productss; they wanted to send out information in a highly effective direction if it was possible; direct mails (DM) and media advertising were costly and time-consuming; and even if they sent out DMs, the response was weak. In addition, the information providing system of the first embodiment solves the conventional problems and has a variety of unique effects as shown below. That is, wih the present information providing system, the stores are able to continuously reach passing consumers (prospective customers as well as customers including potential customers and existing customers). Thus, the stores can increase purchase opportunities and eliminate the need for costly DMs. Moreover, the stores are capable of easily sending out messages and event information.

1. An information providing system characterized by comprising:
a local ID issuing means of making a computer realize a function of assigning and issuing a local ID, the local ID being a single kind of ID assigned to each of plural kinds of objects having different attributes, the local ID being a unique identifier for identifying the objects, and the local ID being assigned and issued to each of the objects,
a first storing means of making the computer realize a first storing function of storing in a database the local ID issued for each of the objects, while relating the local ID to an URI of an attribute information proper to the object, and storing in the database, as the URI, at least an external URI, the external URI being a URI associated with an external system,
a second storing means of making the computer, when an information viewer reads out the local ID of the object by an ID reading means of an information viewer terminal as a computer device for viewing information, realize a second storing function of storing in the database the local ID, while relating the local ID to the information viewer,
a first display means of making the computer realize a first display function of assigning a link to the URI for each of the local IDs based on the local ID and the URI that are stored in the database, and displaying a title associated with the URI, which is related to the local ID that has been read out by the information viewer through the ID reading means, on the information viewer terminal of the information viewer, and
a second display means of making the computer, when the information viewer selects and executes the link of the URI of the object displayed on the information viewer terminal, realize a second display function of displaying the attribute information proper to the object on the information viewer terminal.

2. An information providing system characterized by comprising:
a local ID issuing means of making a computer realize a function of assigning and issuing a local ID, the local ID being a single kind of ID assigned to each of plural kinds of objects having different attributes, the local ID being a unique identifier for identifying the objects, and the local ID being assigned and issued to each of the objects,
a first storing means of making the computer realize a first storing function of storing in a database the local ID issued for each of the objects, while relating the local ID to an URI of an attribute information proper to the object,
a guest key storing means of making the computer, when an information viewer accesses the database for the first time through an information viewer terminal as a computer device for viewing information, realize a guest key storing function of assigning a guest key proper to the information viewer and storing in the database the guest key, while relating the guest key to the information viewer,
a second storing means of making the computer, when the information viewer to whom the guest key is related reads out the local ID of the object by an ID reading means of the information viewer terminal, realize a second storing function of storing in the database the local ID by referring to the guest key of the information viewer, while relating the local ID to the information viewer,
a first display means of making the computer realize a first display function of assigning a link to the URI for each of the local IDs based on the local ID and the URI that are stored in the database, and displaying a title associated with the URI, which is related to the local ID that has been read out by the information viewer through the ID reading means, on the information viewer terminal of the information viewer, and
a second display means of making the computer, when the information viewer selects and executes the link of the URI of the object displayed on the information viewer terminal, realize a second display function of displaying the attribute information proper to the object on the information viewer terminal.

3. An information providing system characterized by comprising:
a local ID issuing means of making a computer realize a function of assigning and issuing a local ID, the local ID being a single kind of ID assigned to each of plural kinds of objects having different attributes, the local ID being a unique identifier for identifying the objects, and the local ID being assigned and issued to each of the objects,
a first storing means of making the computer realize a first storing function of storing in a database the local ID issued for each of the objects, while relating the local ID to an URI of an attribute information proper to the object,
an identifying means of making the computer, when an information viewer accesses and logs in the database for the first time by reading out the local ID of the object through an ID reading means of an information viewer terminal as a computer device for viewing information, realize a function of creating a first table proper to the information viewer and storing the local ID in the first table, and, when the information viewer accesses and logs in the database for the second and further time, realize an identifying function of storing the local ID, which has been stored in the first table that is proper to the information viewer, in the first table as an owner node ID proper to the information viewer so as to identify the information viewer as an owner,
a second storing means of making the computer, when the information viewer to whom the first table is created reads out the local ID of the object by an ID reading means of the information viewer terminal, realize a second storing function of storing in the database the local ID by referring to the guest key of the information viewer, while relating the local ID to the information viewer,
a first display means of making the computer realize a first display function of assigning a link to the URI for each of the local IDs based on the local ID and the URI that are stored in the database, and displaying a title associated with the URI, which is related to the local ID that has been read out by the information viewer through the ID reading means, on the information viewer terminal of the information viewer, and
a second display means of making the computer, when the information viewer selects and executes the link of the URI of the object displayed on the information viewer terminal, realize a second display function of displaying the attribute information proper to the object on the information viewer terminal.

4. An information providing system as recited in claim 1, characterized in that:
the first storing means further stores in the database a second ID, which serves as an ID for identifying types of the plural kinds of objects having different attributes, for each of the plural kinds of objects having different attributes,
the second storing means stores, when the information viewer the local ID of the object through the ID reading means, the local ID in the database, while relating the local ID to the information viewer, and storing the second ID in the database, while relating the second ID to the local ID, and
the first display means, in response to a demand of the information viewer after the information viewer reads out the local ID through the ID reading means, displays the title associated with the URI, which is related to the local ID, on the information viewer terminal of the information viewer, and the first display means classifies the titles associated with the URIs according to the types of the objects associated with the local IDs by referring to the second IDs related to the local IDs so as to display the titles on the information viewer terminal of the information viewer.

5. An information providing system as recited in claim 1 characterized in that:
the local ID issuing means assigns and issues the single kind of local ID to the objects that at least includes a first object having an attribute relating to people, a second object having an attribute relating to an object, a third object having an attribute relating to a thing, and a fourth object having an attribute relating to a place, as the plural kinds of objects having different attributes.

6. An information providing system as recited in claim 1, characterized in that:
the second storing means makes the computer realize either function of a bookmark registration function and a browsing history stroing function, wherein the bookmark registration function prompts the information viewer, after the information viewer reads out the local ID of the object, to select whether or not to bookmark and register the object as a favorite so that the the bookmark registration function bookmarks and registers the object in the database only if the information viewer selects to bookmark and register the object as the favorite, whereas the browsing history storing function stores in the databas, as a browsing history, all of the local IDs of the objects that the information viewer reads out through the ID reading means, and
the first display means makes the computer realize either function of a first list display function and a second list display function, wherein the first list display function displays, on the information viewer terminal of the information viewer, a list of the titles associated with the URIs of the objects that have been bookmarked and registered in the database, whereas the second list display function displays, on the information viewer terminal of the information viewer, a list of the titles associated with the URIs of the objects of the browsing history that has been stored in the database.

7. An information providing system as recited in claim 1, characterized by further comprising:
a third storing means of making the computer realize, when the information viewer reads out the local ID of a first one of the objects so as to store the local ID of the first one of the objects in the database through the second storing means and thereafter the information viewer reads out the local ID of a second one of the objects, to which the local ID different from the local ID of the first one of the objects is assigned, a third storing function of storing in the database a link information representing a relation between the local ID of the first one of the objects and the local ID of the second one of the objects.

8. An information providing system as recited in claim 1, characterized in that the external URI is an external URI uniquely identifying an external web page that is stored in a web server at an outside of the information providing system.

9.-13 (canceled)
